(19) United States
(12) Patent Application Publication
(10) Pub. No.: US 2021/0086584 A1
(43) Pub. Date: Mar. 25, 2021

(54) METHOD FOR CONTROLLING A TEMPERATURE CONTROL DEVICE, TEMPERATURE CONTROL DEVICE, MOTOR VEHICLE AND COMPUTER PROGRAM PRODUCT

(71) Applicant: Ford Global Technologies, LLC, Dearborn, MI (US)

(72) Inventors: Bernd Brinkmann, Dormagen (DE); Christian Jolk, Cololgne (DE); Thomas Nitsche, Neuss (DE); Johann Hendrik Wegers, Koln (DE)

(21) Appl. No.: 17/026,649

(22) Filed: Sep. 21, 2020

(30) Foreign Application Priority Data
Sep. 25, 2019 (DE) 102019125825.1

(51) Int. Cl. B60H 1/00

(52) U.S. Cl. CPC B60H 1/00878; B60H 1/004; B60H 1/00985; B60H 1/005

(57) ABSTRACT

A method controls a temperature control device of an accumulator of a motor vehicle feeding an electric motor. The method includes a check for the presence of an interaction with a communication input of the motor vehicle 1 and, in the presence of an interaction, outputs a control signal to a temperature control device designed for controlling the temperature of the accumulator to a target temperature in a predetermined temperature range. The control signal causes a change of the temperature control of the accumulator.

### CROSS-REFERENCE TO RELATED APPLICATIONS

This application claims priority to DE Patent Application No. 102019125825.1, which was filed on 25 Sep. 2019 and is incorporated herein by reference in its entirety.

### TECHNICAL FIELD

The present disclosure relates to a method for controlling a temperature control device of an accumulator of a motor vehicle feeding an electric motor. Moreover, the present disclosure relates to a device for data processing, a temperature control device, a motor vehicle, a computer program product, and a computer-readable data carrier.

### BACKGROUND

Motor vehicles comprising a drive unit having an accumulator are present in road traffic in different forms. The motor vehicles differ mainly in whether the motor vehicle is operated purely electrically or whether the motor vehicle has a different type of propulsion in addition to an electric drive. In most cases, the other drive unit is an internal combustion engine. A combination of two technically different drive units, wherein one of the two drive units is an electric drive unit, is usually referred to as a hybrid drive and the associated motor vehicles as hybrid vehicles.

In the case of hybrid vehicles, a distinction can be made between a parallel hybrid vehicle and a series hybrid vehicle. In the case of the parallel hybrid vehicle, both motors of the motor vehicle, i.e. the internal combustion engine and the electric motor, can drive the motor vehicle directly (parallel drive structure). The electric drive as well as the further drive are independent of each other.

In a series hybrid vehicle, the internal combustion engine is upstream of the electric motor (serial drive setup). The internal combustion engine drives a generator that generates electricity to power the electric motor and is not connected to the wheels. In the case of a series hybrid vehicle, the motor vehicle is therefore moved exclusively by an electric drive. The electric motor is powered either by the generator driven by the internal combustion engine or, in particular with a low power requirement, from an accumulator of the motor vehicle.

Furthermore, hybrid vehicles can be subdivided according to the proportion of electrical power, for example into a mild hybrid vehicle or a full hybrid vehicle. In a mild hybrid vehicle, the electric motor is used to increase the power of the internal combustion engine. Purely electrical operation is not possible over longer distances. A full hybrid vehicle means that the motor vehicle can be operated purely electromotively and therefore the internal combustion engine can be disconnected and switched off. The electric motor, which is powered solely from the accumulator, then completely takes over the drive power.

A motor vehicle which is purely electrically driven can be described as an electric vehicle. The electric vehicle can be driven with only one or with more electric motors. The electric motors are fed by an accumulator. The accumulator used in an electric vehicle usually has a higher capacity than an accumulator in a hybrid vehicle.

Each electric vehicle and most hybrid vehicles have one or more accumulators for storing electrical energy. Due to the high mass and the large spatial extent of currently available accumulators as well as existing regulations, the accumulator is usually arranged in the area under the seats or in the luggage compartment. This allows a low center of gravity of the vehicle and thus a good road position combined with a more stable driving behavior.

Heat is released both during charging and during discharging of the accumulator, for example during electric driving. A current trend in the industry is to charge accumulators of electrically powered vehicles quickly, for example with charging capacities above 140 kW. The fast charging of the accumulator can lead to intense heating of the accumulator. Driving under high load can also leads to intense heating, for example when driving at a high speed, when the driver has sporty driving behavior or when a heavy vehicle is driving up a mountain.

The heat released can be dissipated to avoid overheating of the accumulator. In an example, some accumulators should not exceed a temperature limit of 45° C. Compliance with a certain temperature range also depends on how much of the stored energy can be taken from the accumulator. If the temperature range is maintained and depending on other factors, such as the state of charge or the power with which the stored energy is extracted, currently between 85% and 95% of the stored energy can be withdrawn.

For heat dissipation, a cooling device is often provided, which actively cools the accumulator by means of a coolant, wherein the coolant can be transported in a cooling circuit and in turn is cooled by means of a cooling machine.

On the one hand, contact of the coolant with the accumulator is typically prevented. To this end, the accumulator is usually surrounded by a housing and the heat transfer takes place via the housing. The contact surface formed for heat transfer between the accumulator and the housing on the one hand and the housing and the coolant on the other hand is very limited by the predetermined design and the limited installation space in the motor vehicle. In addition, the cooling power of the cooling device is also limited by the available installation space, which often does not allow larger dimensioning of the cooling device. A typical maximum possible cooling power in a motor vehicle is about 3 kW.

On the other hand, the transferable amount of heat depends on the temperature difference of the two thermodynamic systems involved, so that more heat can be transferred when either the temperature of the coolant is low, or the temperature of the accumulator is high. In addition to the size of the contact surface, heat transfer is therefore mainly limited by the temperature ceiling of today's accumulators.

If the cooling device is no longer able to cool the accumulator sufficiently, the charging power or the power of the electric motor may be automatically reduced to limit heat generation and to avoid damage to the accumulator. This can lead to restrictions on the use of the vehicle equipped with the accumulator.

Overheating of the accumulator can be avoided if it can be determined in advance when an increase in the power of the electric motor and thus an increase in the load of the accumulator feeding the electric motor can be expected. In this case, the accumulator feeding the electric motor can be cooled accordingly at an early stage. For such an assessment, an algorithm is typically used which incorporates into the estimation the ambient temperature, other environmental parameters as well as information from a navigation system.

DE 10 2012 204 410 A1 discloses a method for operating a battery arrangement of a motor vehicle. In particular, the method is designed to operate a traction battery. The operation of the traction battery of the motor vehicle depends on expected environmental conditions (temperature predictions) and operating parameters of the motor vehicle (route data of a navigation system). In the event of an expected energy withdrawal from the traction battery, heat loss is calculated on the basis of this expected energy withdrawal. A temperature curve of the traction battery is determined on the basis of the calculated heat loss, the expected environmental conditions, and the operating parameters of the motor vehicle. A temperature of the traction battery is then set.

DE 10 2009 046 568 A1 discloses a method for operating vehicles with an electric drive. The electric drive is operated with a control strategy dependent on a distance to be travelled. The control strategy is aimed in particular at intelligent temperature control of the traction batteries arranged in the motor vehicles.

DE 10 2014 204 260 A1 discloses a method of controlling an electric vehicle connected to an external power source. The method is aimed at charging a traction battery to a targeted charge status as well as conditioning the battery to a targeted battery temperature. Conditioning is carried out according to a charging profile based on a user-initiated request for vehicle conditioning.

U.S. Pat. No. 8,620,506 B2 discloses a method for regulating a temperature of an electrically powered vehicle. A controller regulates the temperature of a traction battery so that the temperature of the traction battery is within a temperature range. The temperature control takes place while the motor vehicle is in motion. The control depends on the ambient temperature.

DE 10 2016 216 778 A1 discloses a method for operating a thermal management device of a traction battery of a motor vehicle. The thermal management depends on the deviation of the motor vehicle from a horizontal road position. As a result of changing the road position relative to the horizon, load changes in the motor vehicle are predicted that affect thermal management.

U.S. Pat. No. 9,457,682 B2 discloses a method designed to determine the duration of a future charging process of a battery of a motor vehicle. By estimating the duration of a future charging process, the temperature of the vehicle's battery can be kept below a temperature threshold during the coating process.

US 2016/0107526 A1 discloses a battery system for a motor vehicle, wherein the temperature of the battery is regulated depending on a predicted driving behavior.

US 2014/0012447 A1 discloses a method for charging a battery stack of a motor vehicle. The temperature of the battery stack is controlled and regulated during the charging process.

U.S. Pat. No. 8,410,760 B2 discloses a method for checking the temperature of a battery stack in an electrically operated motor vehicle. A controller sets a minimum allowable operating temperature threshold of the battery stack, wherein the minimum operating temperature threshold depends on the state of charge and the life of the battery stack. A heating system ensures that the temperature of the battery stack does not fall below the operating temperature threshold.

US 2018/0 287 225 A1 discloses a cooling system for a high-voltage battery stack of an electrically operated motor vehicle.

Thus, there are known methods that avoid both overheating and excessive cooling of the accumulator in a predictable driving situation or in a charging situation, for example in a regularly recurring driving situation or in the case of a driving situation estimated from journeys completed. However, the prior art does not disclose a solution to prevent the accumulator from overheating in unforeseeable driving situations.

Moreover, it should also be borne in mind that the cooling device requires electrical energy to cool the accumulator, including cooling the coolant and forming the cooling circuit. The more intensively the accumulator is cooled, the worse the energy balance of the motor vehicle.

### SUMMARY

The present disclosure details options that are improved compared to the prior art for the temperature control of an accumulator

A first aspect of the disclosure relates to a method of controlling a temperature control device of an accumulator feeding an electric motor of a motor vehicle. The method includes checking for the existence of an interaction, for example of a driver of the motor vehicle, with a communication unit of the motor vehicle. In the presence of an interaction, a control signal is output to a temperature control device, which is designed for controlling the temperature of the accumulator to a target temperature in a predetermined temperature range. The control signal causes a change in the temperature control of the accumulator.

Subsequently, the accumulator can be temperature-controlled to the target temperature by means of the temperature control device based on the control signal.

A motor vehicle is a vehicle which can be operated by a motor, such as a land vehicle, an aircraft, or a watercraft. The motor vehicle may be designed as an electric vehicle or a hybrid electric vehicle, for example as a mild hybrid electric vehicle or a full hybrid electric vehicle. For example, the accumulator may be a traction battery of an electric vehicle or a hybrid electric vehicle.

In a first step of the method, it is checked whether there is an interaction with a communication unit, also known as the Human Machine Interface (HMI). The interaction can also be understood as an input into the communication unit. For example, the interaction may have been due to a voice command and/or a haptic input. Furthermore, the interaction may be carried out while the motor vehicle is in motion and/or while the vehicle is at a standstill. The interaction may have been carried out, for example, by the driver of the motor vehicle or by another authorized person, such as the passenger or an occupant of the vehicle.

The communication unit is designed to register the interaction. If there is an interaction, a control signal is generated and output to a temperature control device of the accumulator.

The temperature control device is designed to cool the accumulator. It can optionally also be designed to heat the accumulator under certain conditions. The purpose of the temperature control device is to keep the temperature of the accumulator within a predetermined temperature range, which is limited by a lower limit temperature, for example in the range between 5° C. and 15° C., and an upper limit temperature, for example in the range between 40° C. and 50° C. The lower limit temperature and the upper limit temperature should be selected in such a way that energy withdrawal is possible without temperature-induced damage to the accumulator at a temperature of the accumulator within the temperature range.

In addition, a target temperature within the temperature range is specified. The target temperature may be predetermined depending on certain operating conditions, for example the ambient temperature, a route to be completed, etc. It is self-evident to the person skilled in the art that the target temperature may be provided with a predetermined tolerance range, so that it is therefore a target temperature range. For better comprehensibility, however, the term target temperature is used uniformly below.

The temperature control device may have a cooling circuit in which a coolant circulates. By transferring heat from the accumulator to the coolant, the accumulator can be cooled. The heated coolant can then be cooled by heat transfer to for example air or a refrigerant before it reaches the accumulator again. Consequently, the temperature control device can optionally have a refrigeration machine. Furthermore optionally, the temperature control device can also have a heating device.

For controlling the temperature of the accumulator, its temperature can be determined by means of a temperature sensor or estimated on the basis of operating conditions, for example the charging power and the elapsed duration during a charging process. It can then be checked whether the temperature of the accumulator is within the predetermined temperature range. If the temperature of the accumulator is above the upper limit temperature, cooling of the accumulator is initiated or intensified when cooling is already taking place. The cooling of the accumulator can be initiated or intensified by, for example, cooling the coolant to a lower temperature than the temperature of the accumulator or the current coolant temperature.

Optionally, at a temperature of the accumulator below the lower limit temperature, heating of the accumulator can be initiated or intensified in the event of already occurring heating. The heating of the accumulator can be initiated or intensified by, for example, heating the coolant to a higher temperature than the current temperature of the accumulator or the current coolant temperature.

In addition, the flow rate in the cooling circuit can be varied to influence the temperature of the accumulator.

The control signal causes a change in temperature control compared to an initial state. This can mean that, for example, temperature control is now performed compared to a starting state in which no temperature control takes place. If temperature control already takes place in the initial state, for example, the cooling power of the temperature control device can be increased or decreased compared to an actual state. This allows a target temperature within the temperature range to be reached more quickly. Alternatively or additionally, the target temperature within the temperature range can be changed, for example shifted towards higher or lower temperatures. For example, the target temperature can be shifted to a lower limit temperature of the temperature range.

It is also possible to determine an interaction type and to output different control signals depending on the interaction type detected.

For example, in the presence of a first interaction type a control signal can be output which causes an increase of a cooling power of the temperature control device and/or a shift of the target temperature towards lower temperatures. If there is a second type of interaction, a control signal may be output which causes a reduction in the cooling power of the temperature control device and/or a shift of the target temperature towards higher temperatures. In other words, the two process variants described above can be combined by carrying out different changes in temperature depending on the type of interaction.

For example, the interaction type may have been assigned to the interaction by pressing different buttons on a user interface of the communication device or by using different voice commands.

The disclosure advantageously allows optimized temperature control of the accumulator by also addressing non-automatable predictable changes in the operating conditions of the accumulator.

The accumulator, which feeds the electric motor of the motor vehicle, is charged as soon as power of the electric motor is called up. For example, the power of the electric motor can be called up when the driver of the motor vehicle treads on the accelerator pedal to accelerate spontaneously. Assistance systems of the motor vehicle cannot foresee a spontaneous acceleration of the motor vehicle and thus cannot included this in their algorithm. For example, spontaneous acceleration can occur when a speed limit is lifted after a construction site and the driver of the motor vehicle wants to make up for lost time.

The present disclosure involves spontaneous acceleration. For this purpose, the communication unit will be checked to determine whether there has been an interaction between the driver of the motor vehicle and the communication unit. The interaction of the driver with the communication unit here means that the driver of the motor vehicle must inform the system that an increase in the power of the electric motor and consequently a load on the accumulator are imminent. This interaction with the communication unit causes the temperature control of the accumulator to change. This allows an accumulator temperature adapted to the respective situation to be set by means of the temperature control device.

This may be particularly necessary if the accumulator is already intensively heated, so that a further load on the accumulator without countermeasures would lead to overheating of the accumulator and consequently a limitation of the motor power would intervene in order to reduce the heat development in the accumulator. To prevent this, the method according to the disclosure allows cooling of the accumulator to a lower target temperature and/or reaching the target temperature faster by increasing the cooling power before using the power of the electric motor and thus before increasing the load on the accumulator.

In other words, high or full performance of the accumulator can be provided so that the electric motor can deliver the highest possible power adapted to the accumulator. Especially with a quick call-up of the power of the electric motor, as is the case with spontaneous acceleration, for example during overtaking or during acceleration from a standstill, the provision of the full power of the electric motor can lead to greater driving comfort, which, for example, appeals to aficionados of sporty driving. In addition, maintaining the full power of the electric motor in hazardous situations can be advantageous when rapid acceleration prevents a worse situation. Drivers with sporty driving behavior also welcome maintaining the full power of the electric motor, for example, if the speed limit on a motorway is lifted and the driver can accelerate the vehicle to the maximum. These effects can help to avoid previously occurring negative situations and characteristics of electric vehicles and hybrid vehicles and can contribute to greater acceptance of these vehicles.

If the target temperature is shifted to a lower limit temperature of the temperature range, the accumulator can be protected from overheating in the best possible way. This makes it possible to operate the electric motor with high or even maximum power. This can give the driver of the vehicle a good driving experience.

The reverse case, namely a reduction in cooling, for example by reducing cooling power and/or shifting the target temperature towards higher temperatures, can contribute to a reduction in the energy requirement for cooling and, consequently, to an improved energy balance and extended range of the motor vehicle.

If, for example, only a short driving distance is to be completed, in which cooling of the accumulator would have no effect until the destination is reached, cooling can be dispensed with from the outset. If, for example, a longer travel interruption is envisaged, during which there is no heat development in the accumulator, cooling may also be unnecessary or at least reduced. For example, the driver can identify these situations by interacting with the communication unit. When the interaction is present, the temperature control of the accumulator is then changed accordingly.

According to one embodiment of the present disclosure, the power output of the accumulator can be limited in the presence of an interaction.

The interaction may be, for example, the interaction that causes a reduction in cooling, such as a reduction in the cooling power of the temperature control device and/or a shift of the target temperature towards higher temperatures. However, it can also be another interaction, where the interactions trigger the corresponding changes after determining the type of interaction.

In the event of an interaction, the power output of the accumulator and thus the power of the electric motor can be limited. As a result, an energy-saving driving style is possible. For example, over short distances the energy-saving driving style can be used to prevent unnecessary loading of the accumulator.

For example, all systems that are not necessary for driving the vehicle can be switched off, so that the accumulator can be protected to the maximum extent while driving. For example, passenger compartment systems, such as the comfort system, can be switched off to save energy. This limitation of the power output of the accumulator can be carried out, for example, if the nearest charging station would otherwise not be reachable.

According to one embodiment of the present disclosure, the method may include outputting information about the current status of the temperature control of the accumulator.

Outputting the information can be carried out by means of the communication unit, for example. Outputting the information can be carried out optically, acoustically and/or haptically.

Outputting information about the current status of the temperature control of the accumulator feeding the electric motor, i.e. displaying the current accumulator temperature, has the advantage that the driver is able to better assess an upcoming situation depending on the current status of the temperature control system and thus depending on the current maximum possible power of the electric motor. For example, a driver of a heavy motor vehicle would be able to better assess whether the full power of the electric motor will be available in time before an upcoming hill. Appropriate countermeasures may be taken if necessary.

In addition, it may be provided that after the information is output it is checked whether there is an interaction with the communication unit which causes the release of the power output of the accumulator. If this is the case, the corresponding power output is enabled.

Moreover, it may be possible to reduce the load on the accumulator. For example, an intense load on the accumulator caused by a comfort system of the passenger compartment can be switched off. Optionally, it is possible to check beforehand whether there is a release for the shutdown.

In the event that the driver of the motor vehicle has misjudged the time to an upcoming driving situation and thus the time until an upcoming load on the accumulator is not sufficient to pre-cool the accumulator accordingly, the comfort system in the passenger compartment can be switched off automatically or by a switch. The comfort system in the passenger compartment typically causes an increased load on the accumulator. In addition, when the comfort system is operating, cooling down the passenger compartment leads to a heat input into the refrigerant circuit. This is used to cool the cooling circuit of the accumulator via a so-called chiller. The additional heat input into the refrigeration system thus means an additional load on the cooling system. The increased load on the accumulator by the comfort system in the passenger compartment leads to increased heating of the accumulator. Switching off the comfort system thus results in faster cooling of the accumulator and thus to possible timely achievement of the corresponding cooling of the accumulator before the upcoming driving situation and thus before the upcoming load on the accumulator.

Another aspect of the disclosure concerns a control unit device that can execute of one of the methods described above. Consequently, such a method can be carried out by means of the device and the advantages of the method are accordingly associated with the device.

The control unit can be realized in hardware and/or software and may be designed physically as a single part or as multiple parts. The control unit can be part of or be integrated into a motor controller.

The control unit may be part of a temperature control apparatus which has a temperature control device and a communication unit in addition to the control unit. The control unit, the temperature control device and the communication unit are connected to each other for signal transmission. Optionally, the temperature control apparatus may have a temperature sensor for determining the accumulator temperature. The temperature control apparatus is designed for the temperature control of an accumulator of a motor vehicle feeding an electric motor.

The communication unit may have a user interface which may be operated for example by voice command and/or haptic input. The communication unit may be operated while the motor vehicle is in motion and/or while the motor vehicle is at a standstill.

The different types of input enable the driver of the motor vehicle to react quickly to a driving situation. The haptic input can be used, for example, in the event of a standstill of the motor vehicle or in a quiet traffic situation. In a hectic driving situation, the use of the user interface by voice command is advantageous. In a critical driving situation, the use of the user interface by voice command could often avoid an escalation of the driving situation.

It may be possible to make adjustments while the motor vehicle is at a standstill which can be easily called up while the motor vehicle is in motion.

Another aspect of the disclosure relates to a motor vehicle which is equipped with a temperature control apparatus according to the disclosure. The motor vehicle may be designed as a hybrid electric vehicle or an electric vehicle.

Another aspect of the disclosure relates to a computer program product which includes commands which, when the program is executed by a computer, cause it to perform a method according to the above description.

A computer program product may be a program code stored on an appropriate medium and/or accessible via an appropriate medium. Any medium suitable for storing software, such as a non-volatile memory installed in a control unit, a DVD, a USB stick, a flash card, or the like, can be used to store the program code. For example, the program code can be accessed over the Internet or an intranet, or over another appropriate wireless or wired network.

Another aspect of the disclosure concerns a computer-readable data carrier on which the computer program product is stored.

To avoid unnecessary duplication of effort and repetition of text in the specification, certain features are described in relation to only one or several aspects or embodiments. However, it is to be understood that, where it is technically possible, features described in relation to any aspect or embodiment may also be used with any other aspect or embodiment.

### BRIEF DESCRIPTION OF THE FIGURES

Further advantages, configurations and further developments which are related to the modular tail assembly according to this disclosure or the motor vehicle according to the disclosure are explained in greater detail on the basis of the exemplary embodiments described below. The features described on the basis of the exemplary embodiments can also be called on for the further development of the modular tail assembly according to this disclosure and also the motor vehicle according to this disclosure. The exemplary embodiments are explained in greater detail on the basis of the following figures.

FIG. 1 shows an exemplary motor vehicle in a schematic representation.

FIG. 2 shows the passenger cell of the motor vehicle in a schematic representation.

FIG. 3 shows a flow chart of an exemplary method.

FIG. 4 shows a flow chart of another exemplary method.

### DETAILED DESCRIPTION

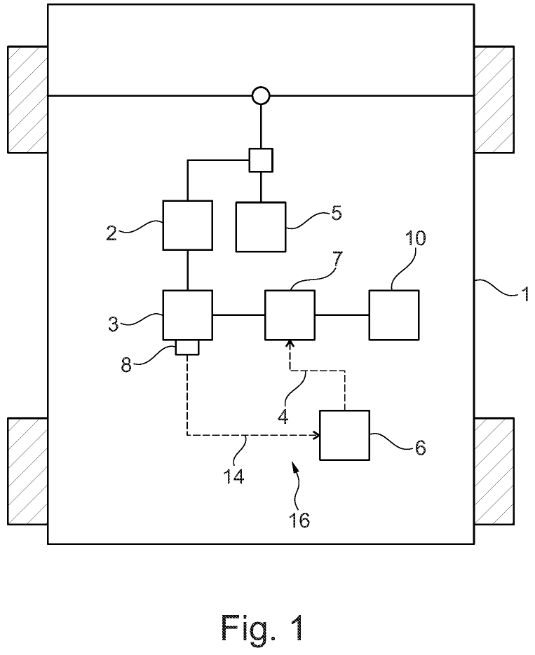

FIG. 1 shows the drive unit of a motor vehicle 1, which has an electric motor 2 and an internal combustion engine 5. Consequently, the motor vehicle 1 is designed as a hybrid vehicle. Optionally, the internal combustion engine 5 can be omitted, so that the motor vehicle 1 is an electric vehicle.

The electric motor 2 is powered by an accumulator 3. The accumulator 3 feeding the electric motor 2 can be temperature controlled by means of a temperature control device 7, in particular cooled. The temperature control device 7 has a signal transmission connection to the control unit 6, i.e., the control unit 6 can output a control signal 4 to the temperature control device 7.

Furthermore, there is a temperature sensor 8 which is designed to determine the temperature of the accumulator 3 and to transmit a corresponding sensor signal 14 to the control unit 6. The sensor signal 14 can be processed by the control unit 6, i.e. the control unit 6 can determine whether the temperature of the accumulator 3 is within a predetermined temperature range. In addition, it can be checked whether a target temperature has been reached. In addition, it is possible to estimate the time at which the target temperature will be reached from the profile of the sensor signal 14.

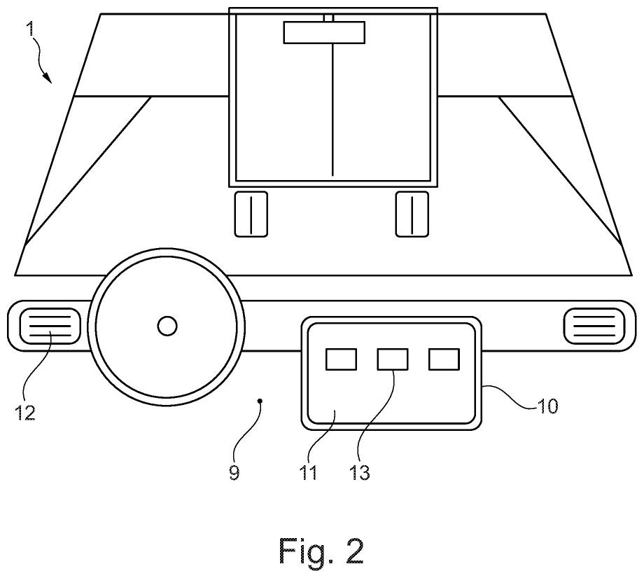

Moreover, the control unit 6 has a signal transmission connection to a communication unit 10, which is arranged in the interior of the motor vehicle (passenger cell) and the design and functionality of which are explained in more detail with reference to FIG. 2. The control unit 6, the temperature control device 7, the temperature sensor 8 and the communication unit 10 together form the temperature control apparatus 16.

The communication unit 10 has a user interface 11 with multiple control panels 13, which can be used for an interaction of the driver of the motor vehicle 1 with the communication unit 10 and to which a different function is assigned. An interaction between the driver of the motor vehicle 1 and the communication unit 10 can thus take place via the haptic control panels 13 or by voice command. The operation of one of these control panels 13 of the user interface 11 of the communication unit 10 leads to an interaction between the driver of the motor vehicle 1 and the communication unit 10.

In the exemplary embodiment, one of the control panels 13 is assigned the function “Increase the cooling of the accumulator 3”. Cooling may be necessary, for example, if the motor vehicle 1 has travelled a long distance, so that the accumulator 3 is already intensively heated by the long drive. A sudden high load on the accumulator 3 could lead to overheating of the accumulator 3. Prior cooling can help to avoid such overheating of the accumulator 3.

Another control panel 13 in the user interface 11 of the communication unit 10 is assigned the function “Reduce the cooling of the accumulator 3”. This avoids unnecessary cooling of the accumulator 3, for example while completing short distances.

An opportunity to protect the accumulator 3 is to switch off the comfort system 12, for example an air conditioning system for the temperature control of the passenger compartment 9, by another control panel 13. This reduces the load on the accumulator 3, so that the motor vehicle 1 can be given a longer range.

FIG. 2 shows a driving situation from the point of view of the driver of the motor vehicle 1. The driver of the motor vehicle 1 is driving behind a truck. Generally, it is not foreseeable how the driver of the motor vehicle 1 will behave during the rest of the journey. For example, a relaxed driver of the motor vehicle 1 would continue his journey behind the truck and would not overtake. However, an impatient driver of the motor vehicle 1 may see the truck as an obstacle and would look for a driving situation in which he can overtake the truck.

A conventional driver assistance system with an algorithm that assesses the further driving situation faces different challenges for both driver variants. The relaxed driver can be better judged by the assistance system than the impatient driver, as the impatient driver's driving behavior is more difficult to predict. An algorithm of the driver assistance system incorporates the driving situations already completed by the drivers into its assessment in order to make a statement as to how the driver of motor vehicle 1 will behave in the upcoming driving situation.

The algorithm of the assistance system, on the other hand, will not detect that a truck is driving ahead of the motor vehicle 1, which is regarded as an obstacle by the impatient driver and not by the relaxed driver. When estimating the upcoming driving situation, the driver assistance system algorithm will provide an estimate for the relaxed driver which states that the motor vehicle 1 will continue to drive behind the truck.

On the other hand, the assessment of the upcoming driving situation is difficult for the impatient driver of the motor vehicle 1 and can be highly inaccurate. For example, the assistance system's algorithm could estimate that it is only a temporary reduction in speed and that the motor vehicle 1 will be accelerated again soon. The algorithm of the assistance system cannot give a more precise indication of the acceleration in the near future. No further information is available to the algorithm of the assistance system.

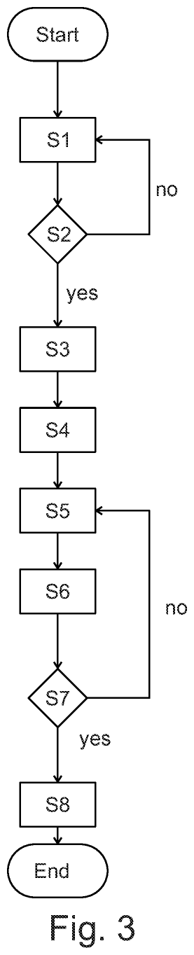

For example, the information required would be whether an upcoming driving situation could occur in which the impatient driver of the motor vehicle 1 could try to overtake the truck. Another piece of information which is available is how bold the impatient driver of the motor vehicle 1 is. For example, a bold driver may be tempted to overtake the truck at inopportune times. A timider, but still impatient, driver of the motor vehicle 1 would wait for a driving situation that may be a little distant in time. The algorithm of the driver assistance system cannot accurately assess and estimate all these driving situations. All the driving situations also have in common that overtaking the truck by the motor vehicle 1 requires high power of the electric motor 2. This in turn requires a high-power output of the accumulator 3 feeding the electric motor 2. All these driving situations associated with the overtaking process are spontaneous and therefore unpredictable by an algorithm. The present disclosure takes into account such spontaneous driving situations. The method shown schematically in FIG. 3 can be used for this purpose, for example.

FIG. 3 represents a flow chart of an exemplary method. After starting the method, the accumulator 3 is temperature controlled in step S1 in a standard mode. This can mean that the accumulator 3 is temperature controlled to a first target temperature within a predetermined temperature range of for example 5 ° C. to 45 ° C., for example 20 ° C. In the case of an ambient temperature exceeding the target temperature and/or when the accumulator 3 is loaded, i.e. charging or discharging, which leads to heat generation, cooling of the accumulator 3 is therefore necessary. Cooling can be done with an initial cooling power.

In the subsequent step S2 it is checked whether there is an interaction with the communication unit 10, i.e. whether one of the control panels 13 of the user interface 11 has been operated. If this is not the case, the method returns to step S1 and the accumulator 3 continues to be temperature controlled in the standard mode.

If, on the other hand, it is determined in step S2 that there is an interaction, the method proceeds to step S3. In step S3, a control signal 4 is output to the temperature control device 7.

Assuming that the function “Increase the cooling of the accumulator” is assigned to the actuated control panel 13, in step S4 the control signal 4 causes a change in the temperature control to intensify the cooling (increased cooling mode). That the function “Increase cooling of the accumulator” is assigned to the operated control panel 13 can be assumed if only one control panel 13 is present or if the interaction type is determined in an intermediate step (not shown). “Intensified cooling mode” may mean that the target temperature is reduced, for example from 20° C. to 10° C. or even to the lower limit temperature of the temperature range, i.e. 5° C., and/or that the cooling power of the temperature control device 7 is increased in order to reach the target temperature faster.

In the following step S5, the accumulator 3 is temperature controlled in the intensified cooling mode.

In step S6, information about the current status of the temperature control of the accumulator 3 is output. This can be carried out by using a display in the user interface 11 of the communication unit 10. Outputting the information can also be continuous.

In step S7 it is checked whether the temperature of the accumulator 3 has reached the target temperature. If this is the case, it is indicated in step S8 that the full power of the accumulator 3 is available and that the accumulator 3 can be loaded intensively. If the target temperature is not yet reached, the method returns to step S5 and the temperature control of the accumulator 3 continues in the intensified cooling mode.

After reaching the target temperature, the method is finished. Optionally, one can switch to a cooling mode that allows the target temperature to be maintained.

The present disclosure is thus aimed at cooling the accumulator 3 feeding the electric motor 2 before an upcoming driving situation, without being dependent on an estimate or an algorithm. An upcoming driving situation, such as an overtaking process, cannot be foreseen by an algorithm. Another unpredictable situation is when the speed limit is lifted at the end of a construction site on a motorway. In order for the driver of the motor vehicle 1 to make up for lost time, the driver would wish to accelerate as quickly as possible once the speed limit has been lifted and make up for lost time. In this situation, the driver expects high power from the electric motor 2. Such use of the accumulator 3 feeding the electric motor 2 leads to a high load and to intensive heating of the accumulator 3. The accumulator 3 feeding the electric motor 2 could then overheat.

The driver of the motor vehicle 1 is informed by means of the communication unit 10 about the current status of the temperature control of the accumulator 3. After receiving information about the status of the temperature control, the driver of the motor vehicle 1 is given the opportunity to release the current maximum available power of the accumulator 3 by means of an interaction with the communication unit 10. Furthermore, after receiving information about the status of the temperature control of the accumulator 3, the driver has the opportunity to switch off the comfort system 12 in the passenger compartment 9 by means of the communication unit 10. The comfort system 12 in the passenger compartment 9 usually causes a heavy load on the accumulator 3. Switching off the comfort system 12 results in a lighter load on the accumulator 3 and thus to faster cooling of the accumulator 3.

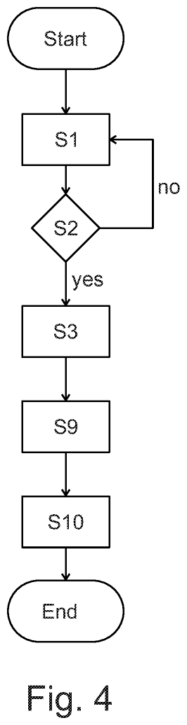

In another exemplary method, which is explained below referring to FIG. 4, the cooling of the accumulator 3 is reduced. This can be useful, for example, if only a short driving distance is to be completed, so that overheating of the accumulator 3 is not expected. Compared to temperature control performed otherwise in standard mode, the energy consumption can be reduced.

As with the method of FIG. 3, the accumulator 3 is first temperature controlled in standard mode after the start of the method and in step S2 it is checked whether there is an interaction with the communication unit 10. If this is not the case, the method returns to step 51.

If, on the other hand, there is an interaction, the method proceeds to step S3 by outputting a control signal 4 to the temperature control device 7. In contrast to the method of FIG. 3, however, in this method the control signal causes a change in the temperature to reduce the cooling (reduced cooling mode). “Reduced cooling mode” may mean that the target temperature is increased, for example, from 20° C. to 25° C., or that cooling is stopped and/or the cooling power of the temperature control device 7 is reduced.

In the following step S10, the accumulator 3 is temperature controlled in the reduced cooling mode. The method can then be terminated.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A method for controlling a temperature control device of an accumulator of a motor vehicle feeding an electric motor, comprising:
checking the existence of an interaction with a communication unit of the motor vehicle; and
in the presence of an interaction, outputting a control signal to a temperature control device designed for controlling the temperature of the accumulator to a target temperature in a predetermined temperature range, wherein the control signal causes a change in the temperature control of the accumulator.

2. The method of claim 1, wherein the control signal causes an increase in a cooling power of the temperature control device.

3. The method of claim 1, wherein the control signal causes a shift of the target temperature towards lower temperatures.

4. The method of claim 3, wherein the control signal causes a shift of the target temperature to a lower limit temperature of the temperature range.

5. The method of claim 1, wherein the control signal causes a reduction of the cooling power of the temperature control device.

6. The method of claim 1, wherein the control signal causes a shift of the target temperature toward higher temperatures.

7. The method of claim 1 further comprising determining an interaction type, wherein mutually different control signals are output depending on the detected interaction type.

8. The method of claim 1 further comprising in the presence of an interaction, limiting the power output of the accumulator.

9. The method of claim 1 further comprising outputting information about the current state of the temperature control of the accumulator.

10. The method of claim 1, wherein the communication unit is a Human Machine Interface.

11. The method of claim 1, wherein the checking occurs when the motor vehicle is driven.

12. A vehicle assembly, comprising:
a temperature control device of an accumulator of a motor vehicle, the accumulator feeding an electric motor; and
a control unit configured to check for the existence of an interaction with a communication unit of the motor vehicle, and, in the presence of an interaction, output a control signal to the temperature control device designed for controlling the temperature of the accumulator to a target temperature in a predetermined temperature range, wherein the control signal causes a change in the temperature control of the accumulator.

13. The vehicle assembly of claim 12, further comprising a motor vehicle having a temperature control apparatus with the temperature control device, the communication unit and the control unit.

14. The vehicle assembly of claim 12, further comprising a Human Machine Interface as the communication unit.

15. The vehicle assembly of claim 12, wherein the control unit is configured to check for the existence of the interaction as the motor vehicle is driven.

16. The vehicle assembly of claim 12, wherein the control signal causes an increase in a cooling power of the temperature control device.

17. The vehicle assembly of claim 12, wherein the control signal causes a shift of the target temperature towards lower temperatures.

18. The vehicle assembly of claim 12, wherein the control signal causes a reduction of the cooling power of the temperature control device.

19. The vehicle assembly of claim 12, wherein the control signal causes a shift of the target temperature toward higher temperatures.
